(19) United States
(12) Patent Application Publication
(10) Pub. No.: US 2012/0198492 A1
(43) Pub. Date: Aug. 2, 2012

(54) Stitching Advertisements Into A Manifest File For Streaming Video

(75) Inventors: Jignesh Yashwant Dhruv, Monmouth Junction, NJ (US); Shalitha Arosha Senanayake, San Francisco, CA (US)

(73) Assignee: CBS Interactive, Inc., San Francisco, CA (US)

(21) Appl. No.: 13/018,092

(22) Filed: Jan. 31, 2011

(51) Int. Cl. H04N 7/025

(52) U.S. Cl. 725/32

(57) ABSTRACT

Disclosed herein are systems, methods, and non-transitory computer-readable storage media for combining advertisements into a manifest file for streaming video content. A system configured to practice the method identifies an advertising slot in a media presentation and retrieves an advertisement corresponding to the advertising slot. Then, the system divides the media presentation into a set of media chunks and divides the advertisement into a set of advertising chunks. The system inserts the set of advertising chunks into the set of media chunks at the advertising slot to yield an updated set of media chunks, and generates a manifest file corresponding to the updated set of media chunks, such as an m3u8 file that contains a series of links to each chunk in the updated set of media chunks. The system optionally transmits the manifest file to a media playback device for playback.

### BACKGROUND

1. Technical Field

The present disclosure relates to media distribution and more specifically to stitching advertisements into streaming media.

2. Introduction

Media distribution, including video distribution, via the Internet is a source of problems for many reasons, including video encoding formats, bandwidth, playback device capabilities, different screen sizes and resolutions, and so forth. Some manufacturers provide a set of guidelines for media distributors as a standard or generally accepted way to stream media to that manufacturer's devices, such as a standard chunk size for streaming media. Certain video playback devices, such as the Apple IPAD, prefer video content to be streamed not continuously, but as a series of discrete “chunks” of video outlined in a manifest file, such as an m3u8 file. The IPAD receives the manifest file that contains links to each of the chunks of video content, and processes the manifest file to retrieve and play back each chunk in turn. However, the m3u8 format imposes several limitations, including the inability to embed other manifest files. This inability to embed other manifest files in the m3u8 format is a hurdle to delivering advertisements and other dynamic interstitial content in streaming video to such devices.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for combining advertisements with a media presentation to generate a manifest file for streaming video content. A system configured to practice the method first identifies an advertising slot, such as a commercial, advertising break, or chapter boundary, in a media presentation and retrieves an advertisement corresponding to the advertising slot. Then the system divides the media presentation into a set of media chunks and divides the advertisement into a set of advertising chunks. The system inserts the set of advertising chunks into the set of media chunks at the advertising slot to yield an updated set of media chunks and generates a manifest file, such as an m3u or m3u8 file, corresponding to the updated set of media chunks. The manifest file can include a series of links to each chunk in the updated set of media chunks. The system can optionally transmit the manifest file to a media playback device for playback. The system can insert tags into the manifest file identifying the advertising segments. Tags can also indicate a duration of the advertisement and/or collection of contiguous advertisements. When the playback device encounters a tag during playback, the tag can trigger the playback device to fetch and display a companion advertisement.

Also disclosed are systems, methods, and non-transitory computer-readable storage media for streaming a video asset to a video playback device. A system configured to practice the method retrieves a video manifest file describing chunks of the video asset. The video manifest file is generated by identifying an advertising slot in a media presentation, retrieving an advertisement corresponding to the advertising slot, dividing the media presentation into a set of media chunks, dividing the advertisement into a set of advertising chunks, inserting the set of advertising chunks into the set of media chunks at the advertising slot to yield an updated set of media chunks, and generating the video manifest file corresponding to the updated set of media chunks. Then the system transmits the video manifest file to the video playback device.

Further disclosed are systems, methods, and non-transitory computer-readable storage media for streaming a video asset to a playback device. A system configured to practice the method first identifies an advertising slot in a media presentation. Then the system retrieves an advertisement corresponding to the advertising slot. The system divides the media presentation into a set of media chunks and divides the advertisement into a set of advertising chunks. Then the system inserts the set of advertising chunks into the set of media chunks at the advertising slot to yield an updated set of media chunks and generates a manifest file corresponding to the updated set of media chunks. The system transmits the manifest file to the playback device. The playback device makes requests to the system for chunks as indicated in the manifest file, and the system streams the updated set of media chunks to the playback device.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure, and are not therefore to be considered to be limiting of its scope, the principles herein are described and explained with additional specificity and detail through the use of the accompanying drawings in which:

FIG. 1A illustrates an example system embodiment;

FIG. 1B illustrates an example media streaming system embodiment;

FIG. 2 illustrates splitting a media file into chunks based on chapter breaks;

FIG. 3 illustrates advertising media split into chunks;

FIG. 4 illustrates the media file chunks with the advertising media chunks at the chapter breaks; and

FIG. 5 illustrates an example method embodiment for generating a video manifest file describing a video asset and streaming the video asset.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

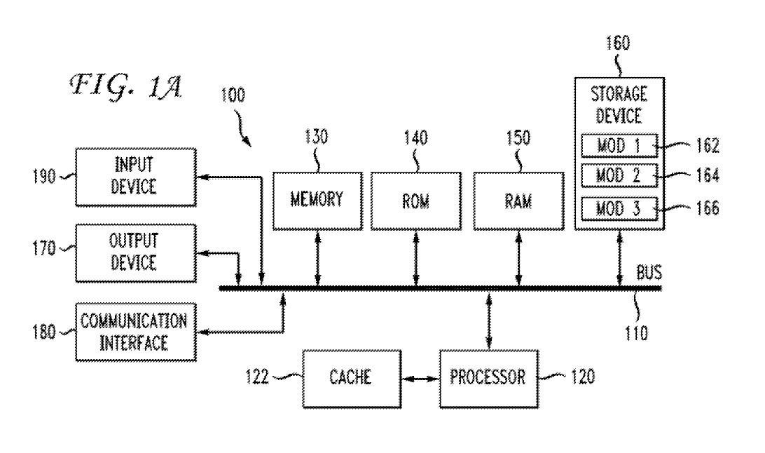

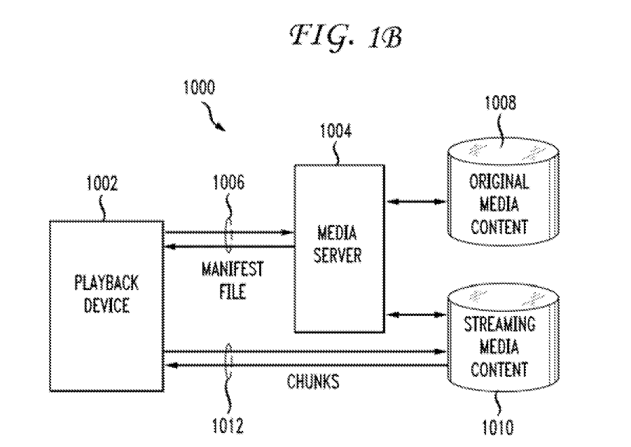

The present disclosure addresses the need in the art for streaming video. A brief introductory description of a basic general-purpose system or computing device in FIG. 1A which can be employed to practice the concepts is disclosed herein. FIG. 1B illustrates an exemplary media-streaming system architecture. A more detailed description of exemplary video manifest files, approaches to “stitching” advertising into a manifest file, and method embodiments will then follow. Variations shall be discussed herein as the various embodiments are set forth. The disclosure now turns to FIG. 1A.

With reference to FIG. 1A, an exemplary system 100 includes a general-purpose computing device 100, including a processing unit (CPU or processor) 120 and a system bus 110 that couples various system components including the system memory 130 such as read-only memory (ROM) 140 and random-access memory (RAM) 150 to the processor 120. The system 100 can include a cache 122 of high-speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general-purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160, such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement, and therefore, the basic features here may easily be substituted for improved hardware or firmware arrangements as they are developed.

For clarity of explanation, the illustrative system embodiment is presented as including individual functional blocks, including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general-purpose processor. For example the functions of one or more processors presented in FIG. 1A may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry, in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1A can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1A illustrates three modules Mod1 162, Mod2 164 and Mod3 166 which are modules configured to control the processor 120. These modules may be stored on the storage device 160 and loaded into RAM 150 or memory 130 at runtime, or may be stored as would be known in the art in other computer-readable memory locations.

Having disclosed some components of a computing system, the disclosure now turns to FIG. 1B, which illustrates an example media streaming system embodiment 1000. The communications between the entities depicted in FIG. 1B can occur via one or more wired or wireless networks. Further, the devices can communicate directly, via the World Wide Web, or via an application programming interface (API). A playback device 1002, such as a tablet device, smartphone, desktop or portable computer, set-top box, Internet-enabled television, media center PC, or any other suitable device, first makes a request to a media server 1004 for playback of media content, such as an episode of Star Trek. Typically, the media server 1004 resides in a network, such as the Internet, but can reside entirely or partially in any of the playback devices or a local network, for example. The media server 1004 receives the request and generates or fetches a manifest file 1006 to send to the playback device 1002 in response to the request. Example formats for the manifest file 1006 include the m3u and m3u8 formats. An m3u8 file is a specific variation of an m3u encoded using UTF-8 Unicode characters. The m3u file format was initially used in the WINAMP Media Player for only audio files, but has since become a de facto playlist standard on many media devices for local and/or streaming media, including music and other media types. Many media devices employ variations of the m3u file format, any of which can be used according to the principles set forth herein. A manifest file can include links to media files as relative or absolute paths to a location on a local file system, or as a network address, such as a Uniform Resource Identifier (URI) path. The m3u8 format is used herein as a non-limiting example to illustrate the principles of manifest files.

The manifest file 1006 includes a list of pointers to sequential chunks of the requested media content. The contents of an example m3u8 manifest file for a 32-second video asset is provided below:

#EXTM3U
#EXT-X-MEDIA-SEQUENCE:0
#EXT-X-TARGETDURATION:10
#EXTINF:10,
http://streaming.exampleurl.com/chunk1.ts
#EXTINF:10,
http://streaming.exampleurl.com/chunk2.ts
#EXTINF:10,
http://streaming.exampleurl.com/chunk3.ts
#EXTINF:2,
http://streaming.exampleurl.com/chunk4.ts
#EXT-X-ENDLIST

Before, or at the time of the request, the media server 1004 generates or identifies the chunks 1012 of the requested media content as streaming media content 1010. The chunks of the streaming media content 1010 are generated, either by the media server 1004, the content producer, or some other entity, by splitting the original media content 1008. Upon receiving the manifest file 1006, the playback device 1002 can fetch a first chunk for playback from the streaming media content 1010, and, during playback of that chunk, fetch a next chunk for playback after the first chunk, and so on, until the end of the media content. The functionality of the entities depicted in FIG. 1B can be split or merged across entities. For example, a first-ingestion server can ingest the original media content 1008 to produce the streaming media content 1010, while a second customer-facing server can service requests for manifest files, and a third media-streaming server streams the actual chunks indicated by the links in the manifest file.

Having set forth the general architecture of streaming media to playback devices, the disclosure turns to a discussion of stitching advertisements into segmented video for streaming, including some specific examples. As set forth above, certain devices, such as the Apple IPAD, require a video manifest file, such as an m3u8 file, for streaming media. One problem with an m3u8 file is that other manifest files cannot be embedded therein. The disclosure now turns to a discussion of how to “stitch” advertisements into a manifest file for presentation to such a playback device.

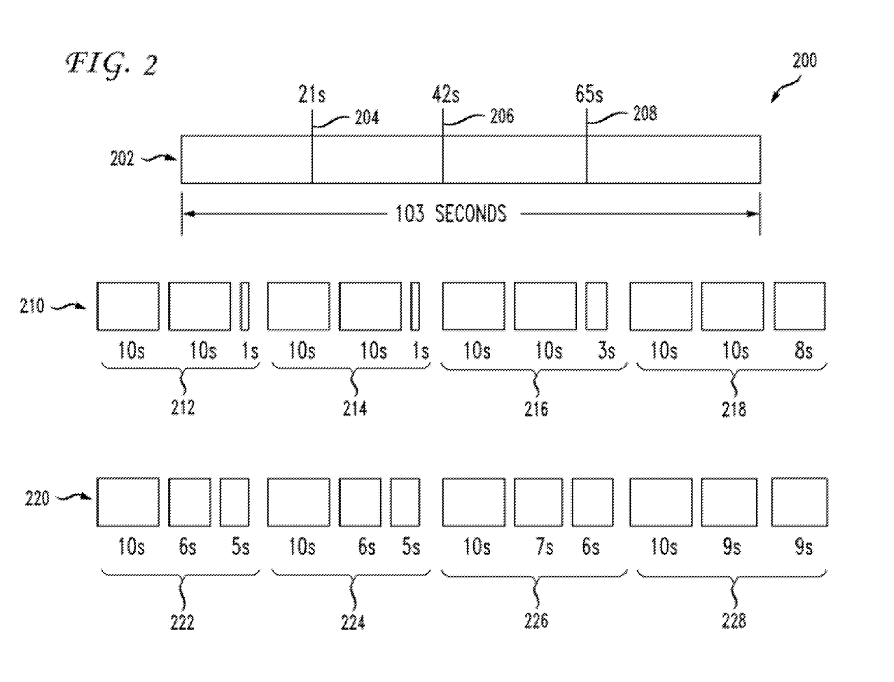

FIG. 2 illustrates an example of segmenting a 103-second media file 202 having chapter breaks 204, 206, 208 into chunks. For purposes of illustration, and not by way of limitation, the examples herein are discussed in terms of a maximum chunk size of 10 seconds and key frames that occur every 1 second. The same principles can be applied in situations with other chunk sizes and key frame frequencies. The media file can be a video file, including video formats such as an MPEG transport stream (or MPEG-TS) file according to ISO/IEC standard 13818-1, an MPEG-4 part 14 (MP4) file according to ISO/IEC standard 14496:14:2003, an Ogg Theora file according to the video compression format developed by the Xiph.org foundation, or other suitable media types, including audio, text, images, video enhancement layers, metadata, interactive media, and so forth. The various media file segments and advertising segments can be of a same or different media file types. For example, the media file segments can be in MPEG-TS format, and the advertising segments can be in MP4 format.

The first set of chunks 210 illustrates the existing approach of placing any remaining time in the final chunk. As can be seen, the first two chapters 212, 214 have a final 1-second chunk and the third chapter 216 a final 2-second chunk, each of which can cause video-streaming performance problems. Only the last chapter 218 has a final chunk of a reasonable size, 8 seconds, and that is at the end of the media file where the final chunk size does not matter as much.

Using a best-fit algorithm for generating chunks based on the chapter boundaries, the segmenter can generate a second set of chunks 220. The first chapter 222 is divided into a 10-second chunk, a 6-second chunk, and a 5-second chunk. The second chapter 224 is divided into a 10-second chunk, a 6-second chunk, and a 5-second chunk. The third chapter 226 is divided into a 10-second chunk, a 7-second chunk, and a 6-second chunk. The fourth chapter 228 is divided into two 10-second chunks and two 9-second chunks. An example m3u8 file for streaming the second set of chunks 220 without any advertisements is provided below:

#EXTM3U
#EXT-X-MEDIA-SEQUENCE:0
#EXT-X-TARGETDURATION:10
#EXTINF:10,
http://streaming.contentserver.com/chapter1_chunk1.ts
#EXTINF:6,
http://streaming.contentserver.com/chapter1_chunk2.ts
#EXTINF:5,
http://streaming.contentserver.com/chapter1_chunk3.ts
#EXTINF:10,
http://streaming.contentserver.com/chapter2_chunk1.ts
#EXTINF:6,
http://streaming.contentserver.com/chapter2_chunk2.ts
#EXTINF:5,
http://streaming.contentserver.com/chapter2_chunk3.ts
#EXTINF:10,
http://streaming.contentserver.com/chapter3_chunk1.ts
#EXTINF:7,
http://streaming.contentserver.com/chapter3_chunk2.ts
#EXTINF:6,
http://streaming.contentserver.com/chapter3_chunk3.ts
#EXTINF:10,
http://streaming.contentserver.com/chapter4_chunk1.ts
#EXTINF:10,
http://streaming.contentserver.com/chapter4_chunk2.ts
#EXTINF:9,
http://streaming.contentserver.com/chapter4_chunk3.ts
#EXTINF:9,
http://streaming.contentserver.com/chapter4_chunk4.ts
#EXT-X-ENDLIST

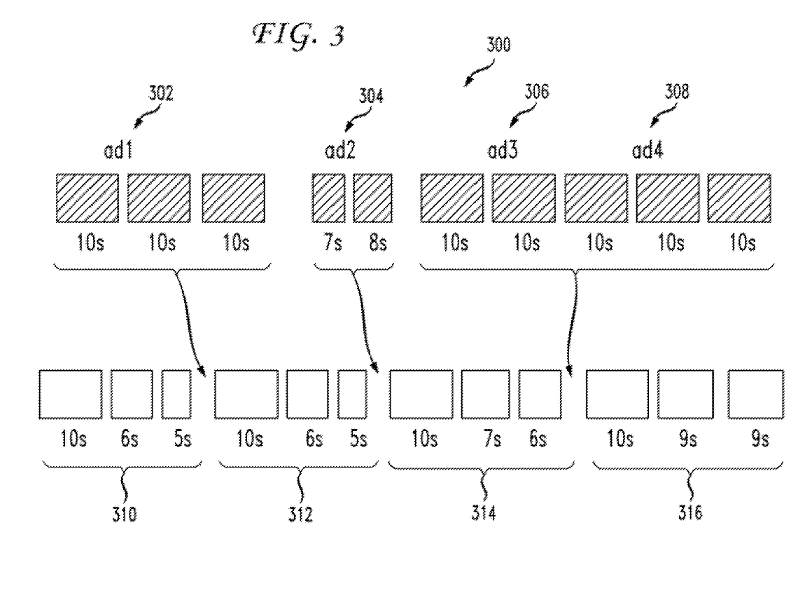

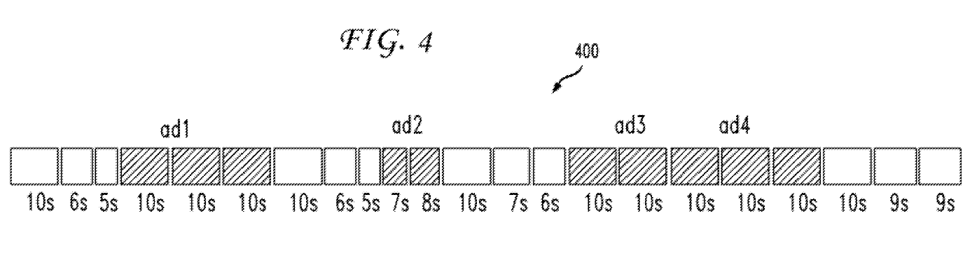

FIG. 3 illustrates advertising media 300, specifically four advertisements 302, 304, 306, 308 already split into chunks. The system identifies the four chapters 222, 224, 226, 228 and the boundaries between the chapters. Then the system can insert, in the manifest file, the advertisements into the respective locations. The system can select and pair the advertisements with breaks randomly or according to time constraints, advertiser fees, media file content, and/or other promotional data. FIG. 4 illustrates the media file chunks 400 with the advertising media chunks inserted at the various chapter breaks. An example manifest file generated by the system with inserted advertising chunks is provided below:

#EXTM3U
#EXT-X-MEDIA-SEQUENCE:0
#EXT-X-TARGETDURATION:10
#EXTINF:10,
http://streaming.contentserver.com/chapter1_chunk1.ts
#EXTINF:6,
http://streaming.contentserver.com/chapter1_chunk2.ts
#EXTINF:5,
http://streaming.contentserver.com/chapter1_chunk3.ts
#AD-BEGIN
#EXTINF:10,
http://streaming.adserver1.com/chunk1.ts
#EXTINF:10,
http://streaming.adserver1.com/chunk2.ts
#EXTINF:10,
http://streaming.adserver1.com/chunk3.ts
#AD-END
#EXTINF:10,
http://streaming.contentserver.com/chapter2_chunk1.ts
#EXTINF:6,
http://streaming.contentserver.com/chapter2_chunk2.ts
#EXTINF:5,
http://streaming.contentserver.com/chapter2_chunk3.ts
#AD-BEGIN
#EXTINF:7,
http://streaming.adserver2.com/chunk1.ts
#EXTINF:8,
http://streaming.adserver2.com/chunk2.ts
#AD-END
#EXTINF:10,
http://streaming.contentserver.com/chapter3_chunk1.ts
#EXTINF:7,
http://streaming.contentserver.com/chapter3_chunk2.ts
#EXTINF:6,
http://streaming.contentserver.com/chapter3_chunk3.ts
#AD-BEGIN
#EXTINF:10,
http://streaming.adserver3.com/chunk1.ts
#EXTINF:10,
http://streaming.adserver3.com/chunk2.ts
#EXTINF:10,
http://streaming.adserver3.com/chunk3.ts
#EXTINF:10,
http://streaming.adserver4.com/chunk1.ts
#EXTINF:10,
http://streaming.adserver4.com/chunk2.ts
#EXTINF:10,
http://streaming.adserver4.com/chunk3.ts
#AD-END
#EXTINF:10,
http://streaming.contentserver.com/chapter4_chunk1.ts
#EXTINF:10,
http://streaming.contentserver.com/chapter4_chunk2.ts
#EXTINF:9,
http://streaming.contentserver.com/chapter4_chunk3.ts
#EXTINF:9,
http://streaming.contentserver.com/chapter4_chunk4.ts
#EXT-X-ENDLIST

As this example illustrates, while a manifest files is unable to contain other manifest files, the manifest file can contain links to chunks from multiple sources. For instance, the manifest file can include links to chunks on a single-content server and one or more different advertising servers. Alternatively, the manifest file can include links to chunks on a single server that stores both content and advertising. The content chunks, for example, can be stored at different locations, although in a common scenario, a content producer stores all the content chunks on a single server or cluster of servers. When the playback device receives the manifest file, the playback device fetches a first chunk and begins playing that chunk. As that chunk is playing, the playback device fetches the next chunk, and so on.

In one variation for additional content security, each segment (or .ts file) is tokenized at the time the advertisement is stitched in. This approach can result in URLs in the manifest file that are only valid for a predetermined time frame. Outside of the predetermined time frame, the system can remove access to the tokenized segments, delete the tokenized segments, and/or move the tokenized segments to another URL. The predetermined time frame can be different for each chunk listed in the manifest file. For example, the system can determine that chunk X occurs 35 minutes into the media presentation represented by the manifest file. Then, the system can set the predetermined time frame for that chunk to start at the time of the request for the manifest file and to end at the time of the request for the manifest file plus 40 minutes. The beginning and ending of the predetermined time frame can be earlier or later, based on a desired access policy, such as providing the user with the ability to pause, rewind, and fast forward through the video.

For content security and/or digital rights management purposes, the computing device that generates the manifest files can, in one embodiment, only generate manifest files in response to requests originating from one of a list of allowed domains, devices, and/or users. In this way, even if the computing device faces the Internet, only specific allowed users can successfully make requests. Requests not originating from an allowed source are unable to get any content to play.

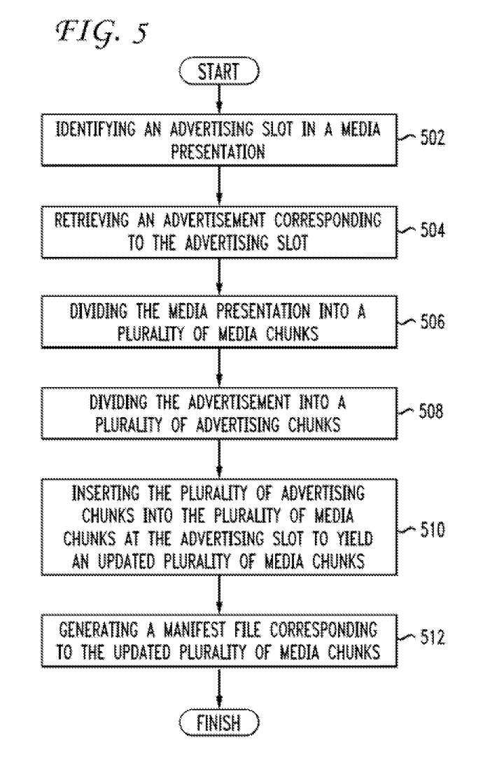

Having disclosed some basic segmenting and advertising insertion concepts for streaming media based on manifest files, the disclosure now turns to the exemplary method embodiment shown in FIG. 5 for generating a video manifest file describing a video asset and streaming the video asset. For the sake of clarity, the method is discussed in terms of an exemplary system 100 as shown in FIG. 1A configured to practice the method. The steps outlined herein are exemplary and can be implemented in any combination thereof, including combinations that exclude, add, or modify certain steps. The exemplary method set forth in FIG. 5 can be triggered by a request from a playback device for a particular piece of media. The system can select and stitch the advertising chunks into the video manifest file on the fly in response to a request. Thus, the system can further retrieve or infer user information, such as user preferences, location, social networking information, demographic information, age, gender, viewing history, purchasing history, and so forth, and select particular advertisements to stitch into the manifest file based on all or part of that information.

The system 100 identifies an advertising slot in a media presentation (502). The advertising slot can be a chapter break, for example. The system can identify multiple advertising slots of different durations in a single media presentation. If the user is a paying subscriber, the system can ignore all or part of the advertising slots, whereas the system inserts advertisements at each advertising slot for a user viewing the media presentation for free. The content producer can indicate possible advertising slots, or the system 100 can analyze the content of the media presentation, metadata, or some other resource to determine the location of appropriate advertising slots.

The system 100 retrieves an advertisement corresponding to the advertising slot (504). The advertisement can be a set of separate advertising messages, such as a commercial break of three different advertisements. The advertisement can be a commercial, preview, station identifier, logo, public service announcement, or any other advertisement media for insertion into the media presentation during playback. In one aspect, the advertiser can provide multiple different formats of the same advertisement for playback under different circumstances. For example, the advertiser can provide a low-resolution version, a high-resolution version, a 16-bit color version, and so forth, to meet specific bandwidth, device, and/or other requirements. Alternatively, the system can receive the advertisement and transcode the advertisement, before or after dividing the advertisement into chunks, to meet the needs of the playback device. The same principles apply to the media presentation.

The system 100 divides the media presentation into a set of media chunks (506), such as with a “Best Fit” algorithm. Alternatively, a media content producer or other entity has already divided the media presentation into chunks, and the system simply identifies which chunks are part of the media presentation. The system 100 divides the advertisement into a set of advertising chunks (508). Alternatively, the advertiser or other entity has already prepared the advertisement into chunks, and the system simply identifies the advertising chunks and does not divide the advertisement into chunks itself. The system 100 inserts the set of advertising chunks into the set of media chunks at the advertising slot to yield an updated set of media chunks (510) and generates a manifest file corresponding to the updated set of media chunks (512). As discussed above, the manifest file can be an m3u8 file or a MEDIA PLAYER Classic Play List (MPCPL) file that includes links to each chunk in the updated set of media chunks. The video manifest file includes pointers to the updated set of chunks, such that a video playback device can process the pointers sequentially to fetch and play the video asset chunk by chunk.

The system can transmit the manifest file to a media playback device for playback. The system 100 can optionally insert a tag in the manifest file corresponding to the advertising slot. Some example tags include #AD, #AD-DURATION:30, #DISABLE-PLAYBACK-CONTROLS, #ENABLE-PLAYBACK-CONTROLS, and so forth. The tag can designate the set of advertising chunks as the advertisement to a media playback device, and/or indicate a duration of the advertisement. The tag can trigger a media playback device to fetch and display a companion advertisement during playback of the set of advertising chunks. The system can generate chapter break markers and chapter break tags on the fly.

The tag can trigger any behavior on the playback device or other devices, such as disabling media controls, volume control, user's ability to resize the advertisement, and so forth. The tag can include information that the playback device can display to the user, such as total advertising break duration, number of advertisements in the break, and so forth.

The playback device can, based on the tag, trigger the display of the companion advertisement on a separate device. For example, if a user is streaming the media presentation on an IPAD based on a manifest file and the IPAD encounters an advertising tag, the IPAD can send an instruction to the user's nearby IPHONE to display the companion advertisement while the IPAD displays the main advertisement. Advertisements and companion advertisements can be text, audio, video, images, and/or any other media type.

In one variation, the system 100 is a server that provides manifest files to a playback device. The server does not generate the manifest files, but simply serves them to the playback device. In this example, the server retrieves a video manifest file describing chunks of the video asset, generated by identifying an advertising slot in a media presentation, retrieving an advertisement corresponding to the advertising slot, dividing the media presentation into a set of media chunks, dividing the advertisement into a set of advertising chunks, inserting the set of advertising chunks into the set of media chunks at the advertising slot to yield an updated set of media chunks, and generating the video manifest file corresponding to the updated set of media chunks. Then, the server transmits the video manifest file to the video playback device.

In another variation, the system 100 is a server that provides all aspects of streaming media, including dividing the media and advertisements, generating the manifest file, transmitting the manifest file to the playback device, and streaming chunks to the playback device based on the manifest file. The server identifies an advertising slot in a media presentation, retrieves an advertisement corresponding to the advertising slot, divides the media presentation into a set of media chunks, and divides the advertisement into a set of advertising chunks. The server inserts the set of advertising chunks into the set of media chunks at the advertising slot to yield an updated set of media chunks, and generates a manifest file corresponding to the updated set of media chunks. Then, the server transmits the manifest file to the playback device, such as in response to a request for streaming media.

The playback device then parses the manifest file, extracts the link to a first chunk, and begins requesting chunks from the server, starting with the first chunk. The server then streams the updated set of media chunks to the playback device as requested by the playback device based on the manifest file. The playback device can be any media consumption device that receives and/or processes the manifest file. The playback device essentially restitches the media chunks represented in the manifest file to play back the media presentation. The playback device can send a request for a streaming video asset to a media server and receive a video manifest file in response to the request. The video manifest file can be generated by the media server or other entity as set forth above. Then, the playback device can parse the video manifest file to extract a set of links to media chunks corresponding to the streaming video asset and play the streaming video asset by iteratively retrieving a first chunk based on the set of links, and playing the first chunk, while retrieving a next chunk for playback based on the set of links.

The system 100 can be a central media server storing the media presentation chunks, the advertising chunks, and the video manifest file. Alternatively, multiple separate systems can perform different portions of the functionality described herein. In this way, the system can overcome the limitations of existing manifest files for inserting advertisements into streaming media while avoiding the stops, stutters, and imprecise boundary handling in streaming videos with embedded advertisements.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general-purpose or special-purpose computer, including the functional design of any special-purpose processor as discussed above. By way of example, and not limitation, such non-transitory computer-readable media can include RAM, ROM, EEPROM, CD-ROM or other optical disk storage, magnetic disk storage or other magnetic storage devices, or any other medium, which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general-purpose computer, special-purpose computer, or special-purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments, where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be applied to any streaming media that is divided into chunks, including audio playback, text, or elements of an interactive environment. Those skilled in the art will readily recognize various modifications and changes that may be made to the principles described herein without following the example embodiments and applications illustrated and described herein, and without departing from the spirit and scope of the disclosure.

We claim:

1. A method for combining advertisements into streamed video content, the method comprising:
identifying an advertising slot in a media presentation;
retrieving an advertisement corresponding to the advertising slot;
dividing the media presentation into a plurality of media chunks;
dividing the advertisement into a plurality of advertising chunks;
inserting the plurality of advertising chunks into the plurality of media chunks at the advertising slot to yield an updated plurality of media chunks; and
generating a manifest file corresponding to the updated plurality of media chunks.

2. The method of claim 1, further comprising transmitting the manifest file to a media playback device for playback.

3. The method of claim 1, wherein the manifest file is an m3u8 file.

4. The method of claim 1, wherein the manifest file comprises a series of links to each chunk in the updated plurality of media chunks.

5. The method of claim 1, wherein the advertising slot is a chapter break.

6. The method of claim 1, further comprising inserting a tag in the manifest file corresponding to the advertising slot.

7. The method of claim 6, wherein the tag designates the plurality of advertising chunks as the advertisement to a media playback device.

8. The method of claim 6, wherein the tag indicates a duration of the advertisement.

9. The method of claim 6, wherein the tag triggers a media playback device to fetch and display a companion advertisement during playback of the plurality of advertising chunks.

10. The method of claim 1, wherein the advertisement comprises a plurality of separate advertising messages.

11. A system for streaming a video asset to a video playback device, the system comprising:
a processor;
a first module configured to control the processor to retrieve a video manifest file describing chunks of the video asset, wherein the video manifest file is generated by steps comprising:
identifying an advertising slot in a media presentation;
retrieving an advertisement corresponding to the advertising slot;
dividing the media presentation into a plurality of media chunks;
dividing the advertisement into a plurality of advertising chunks;
inserting the plurality of advertising chunks into the plurality of media chunks at the advertising slot to yield an updated plurality of media chunks; and
generating the video manifest file corresponding to the updated plurality of media chunks; and
a second module configured to control the processor to transmit the video manifest file to the video playback device.

12. The system of claim 11, wherein the video manifest file is an m3u8 file.

13. The system of claim 11, wherein the video manifest file comprises a series of links to each chunk in the updated plurality of media chunks.

14. The system of claim 1, wherein the advertising slot is a chapter break.

15. A non-transitory computer-readable storage medium storing instructions which, when executed by a playback device, cause the playback device to play a streaming video asset, the instructions comprising:
sending a request for a streaming video asset to a media server;
receiving a video manifest file in response to the request, the video manifest file generated according to steps comprising:
identifying an advertising slot in a media presentation;
retrieving an advertisement corresponding to the advertising slot;
dividing the media presentation into a plurality of media chunks;
dividing the advertisement into a plurality of advertising chunks;
inserting the plurality of advertising chunks into the plurality of media chunks at the advertising slot to yield an updated plurality of media chunks; and
generating the video manifest file corresponding to the updated plurality of media chunks; and
parsing the video manifest file to extract a set of links to media chunks corresponding to the streaming video asset; and
playing the streaming video asset by iteratively:
retrieving a first chunk based on the set of links; and
playing the first chunk while retrieving a next chunk based on the set of links.

16. The non-transitory computer-readable storage medium of claim 15, wherein the manifest file further comprises a tag corresponding to the advertising slot.

17. The non-transitory computer-readable storage medium of claim 16, wherein the tag designates the plurality of advertising chunks as the advertisement to the media playback device.

18. The non-transitory computer-readable storage medium of claim 16, wherein the tag indicates a duration of the advertisement.

19. The non-transitory computer-readable storage medium of claim 16, wherein the tag triggers the media playback device to fetch and display a companion advertisement during playback of the plurality of advertising chunks.

20. The non-transitory computer-readable storage medium of claim 15, wherein the advertisement comprises a plurality of separate advertising messages.
